(19) United States
(12) Patent Application Publication
(10) Pub. No.: US 2020/0356626 A1
(43) Pub. Date: Nov. 12, 2020

(54) ENHANCED SPELLING CORRECTION

(71) Applicant: Microsoft Technology Licensing, LLC, Redmond, WA (US)

(72) Inventors: James COGLEY, Dublin (IE); Andrew DONOHOE, Dublin (IE); Mary KENNY, Maynooth (IE)

(21) Appl. No.: 16/404,970

(22) Filed: May 7, 2019

(51) Int. Cl. G06F 17/27

(52) U.S. Cl. CPC G06F 17/273; G06F 17/277

(57) ABSTRACT

Enhanced spelling correction is provided. An enhanced spelling correction service may determine any misspellings (e.g., a word of the text containing an identified spelling error) in text using lexicon-based spelling correction. Each misspelling is assigned an error flag. The service can communicate each misspelling to a language model-based spell checker and receive, for each misspelling, an error confidence signal from the language model-based spell checker. For each misspelling having an error confidence signal indicating a low confidence that the identified spelling error is an actual spelling error, the service can determine whether to maintain or suppress the error flag by applying decision logic. In response to determining to maintain the error flag, the service can surface a visual indication of the spelling error. In response to determining to suppress the error flag, the service can suppress the error flag whereby the visual indication of the spelling error is not surfaced.

### BACKGROUND

A spell checker checks for misspellings within text. A typical spell checker compares each word within the text against a list of known words in a dictionary, or lexicon. Any word not included in the lexicon can be indicated as a misspelling.

Spell checkers can be included within many different applications, such as productivity applications. Productivity applications include reading and authoring tools for creating, editing, and consuming documents, presentations, spreadsheets, databases, charts and graphs, images, video, audio, and the like. These applications can be in the form of a word processing software, spreadsheet software, personal information management (PIM) and email communication software, presentation programs, note taking/storytelling software, diagram and flowcharting software, document viewing software, web browser software, and the like. Examples of productivity applications include the MICROSOFT OFFICE suite of applications from Microsoft Corp., such as MICROSOFT WORD, MICROSOFT EXCEL, MICROSOFT ONENOTE, all registered trademarks of Microsoft Corp.

### BRIEF SUMMARY

Enhanced spelling correction is provided. The described enhanced spelling correction combines lexicon-based spelling correction and language model-based spelling correction, with decision logic to improve system precision (e.g., reducing the number of incorrect error flags) while minimizing any recall regressions (e.g., ensuring that the high detection rate of true errors is maintained).

An enhanced spelling correction service may determine any misspellings in text using lexicon-based spelling correction. A misspelling is a word of the text that contains an identified spelling error and each misspelling is assigned an error flag. The enhanced spelling correction service can communicate each misspelling to a language model-based spell checker and receive, for each misspelling, an error confidence signal from the language model-based spell checker. For each misspelling having an error confidence signal indicating a low confidence that the identified spelling error is an actual spelling error, the enhanced spelling correction service can determine whether to maintain or suppress the error flag by applying decision logic. In response to determining to maintain the error flag, the enhanced spelling correction service can surface a visual indication of the spelling error. In response to determining to suppress the error flag, the enhanced spelling correction service can suppress the error flag whereby the visual indication of the spelling error is not surfaced.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example implementation of enhanced spelling correction according to an embodiment of the invention.

FIG. 2A illustrates an example scenario of typical spelling correction.

FIG. 2B illustrates an example scenario of enhanced spelling correction according to an example embodiment of the invention.

FIG. 3 illustrates an example operating environment for enhanced spelling correction.

FIGS. 4A and 4B illustrate example process flow diagrams for enhanced spelling correction according to certain embodiments of the invention.

FIG. 5 illustrates components of a computing device that may be used in certain embodiments described herein.

FIG. 6 illustrates components of a computing system that may be used to implement certain methods and services described herein.

### DETAILED DESCRIPTION

Enhanced spelling correction is provided. The described enhanced spelling correction combines lexicon-based spelling correction and language model-based spelling correction, with decision logic to improve system precision (e.g., reducing the number of incorrect error flags) while minimizing any recall regressions (e.g., ensuring that the high detection rate of true errors is maintained).

Currently, lexicon-based spelling correction is performed through two stages: verify and suggest. The verify stage identifies any spelling errors within a given text, and the suggest stage will retrieve any spelling suggestions from the orthographic speller as well as perform a service to service call to a language model-based spell checker for any additional spelling suggestions.

Lexicon-based spelling correction approaches can have high flagging recall, however expansion of this approach into the “long tail” of words used in a given language can be expensive as human intervention is required to add newly discovered words.

Language model-based spelling correction approaches can be easily extendable, with the provision of more data. However, such approaches can encounter low flagging recall as they can be skewed by commonly mistyped words.

Advantageously, the described enhanced spelling correction facilitates the growth and comprehensive coverage of a lexicon through the use of a language modeling approach. This is combined with a lexicon-based orthographic speller and decision logic to ensure high flagging recall. In particular, the decision logic can include a linguistic rule set to help ensure that linguistic rules are adhered to as well as eliminating common mistakes that language models may have.

As an example, an error confidence signal can be used to reduce the number of false error flags on named entities and decision logic can be used to reduce the likelihood that a true error flag is unflagged. Indeed, the rate of proper names being flagged as spelling errors can be greatly reduced. For example, the decision logic can focus on what a proper name looks like without developing something like a named entity recognizer and while also minimizing common error types that language models don't capture.

An enhanced spelling correction service may determine any misspellings in text using lexicon-based spelling correction. A misspelling is a word of the text that contains an identified spelling error and each misspelling is assigned an error flag. The enhanced spelling correction service can communicate each misspelling to a language model-based spell checker and receive, for each misspelling, an error confidence signal from the language model-based spell checker. For each misspelling having an error confidence signal indicating a low confidence that the identified spelling error is an actual spelling error, the enhanced spelling correction service can determine whether to maintain or suppress the error flag by applying decision logic. In response to determining to maintain the error flag, the enhanced spelling correction service (or application receiving result of the flag from the enhanced spelling correction service) can surface a visual indication of the spelling error. In response to determining to suppress the error flag, the enhanced spelling correction service can suppress the error flag whereby the visual indication of the spelling error is not surfaced.

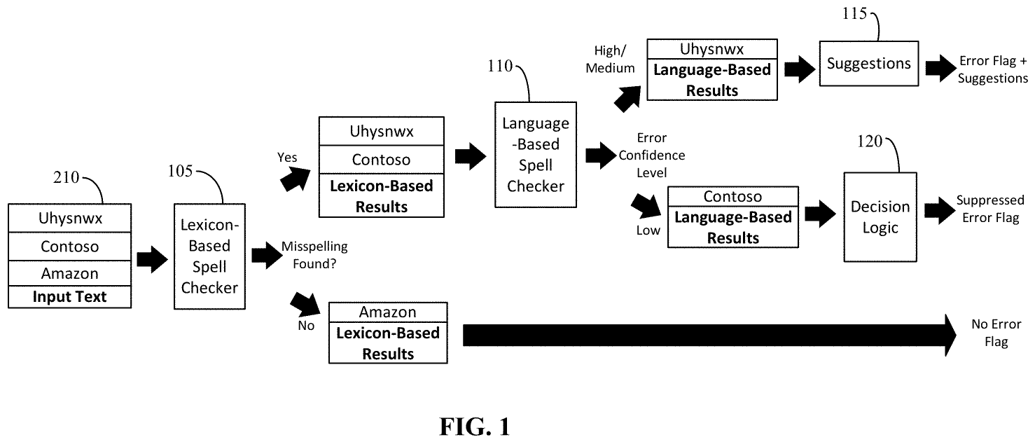

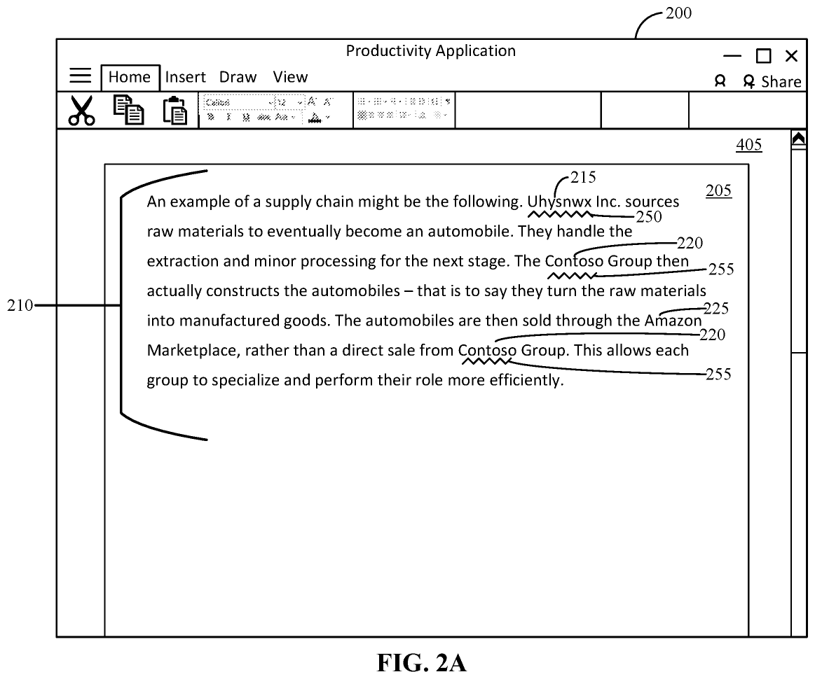

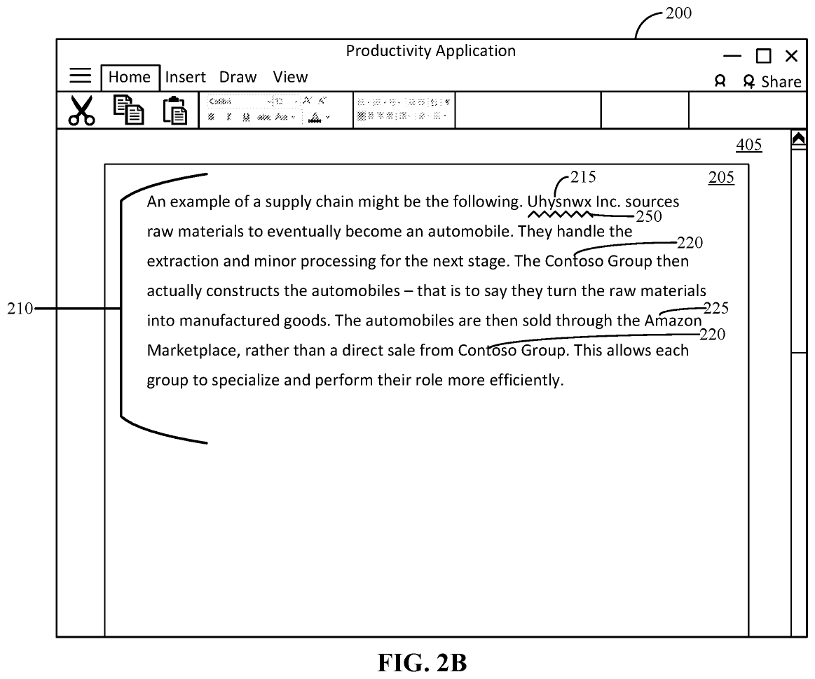

FIG. 1 illustrates an example implementation of enhanced spelling correction according to an embodiment of the invention; FIG. 2A illustrates an example scenario of typical spelling correction; and FIG. 2B illustrates an example scenario of enhanced spelling correction according to an example embodiment of the invention.

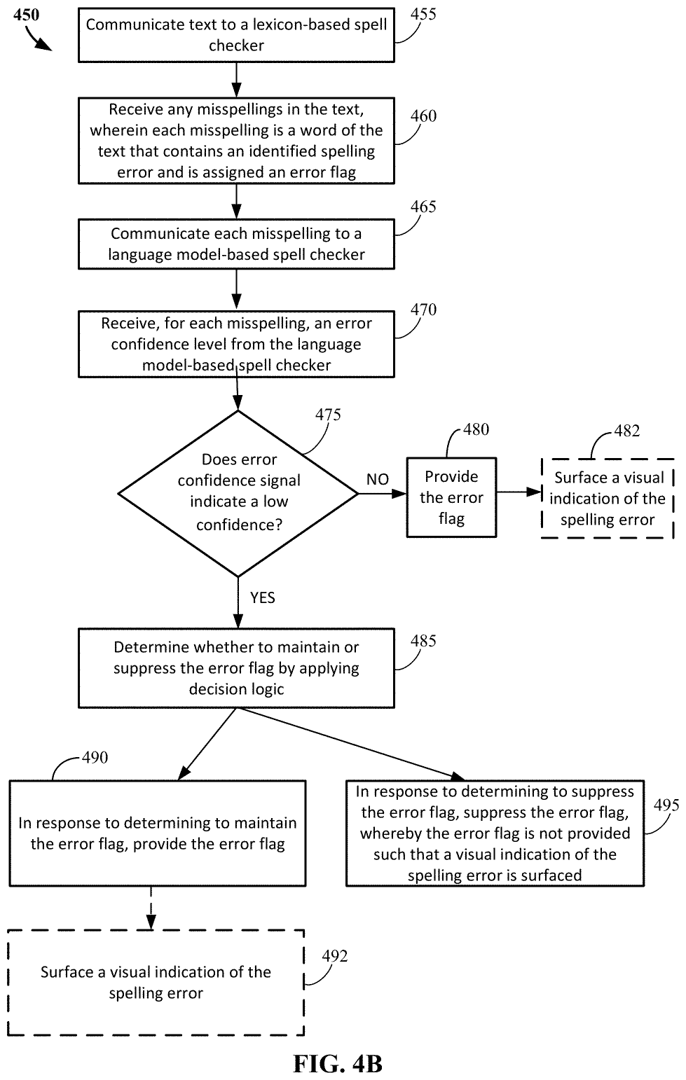

Referring to FIGS. 2A and 2B, a user may open a canvas interface 205 of a productivity application 200 on their computing device (embodied, for example, as system 500 described with respect to FIG. 5). The computing device may be, but is not limited to, a personal computer, a laptop computer, a desktop computer, a tablet computer, a reader, a mobile device, a personal digital assistant, a smart phone, a gaming device or console, a wearable computer, a wearable computer with an optical head-mounted display, smart watch, or a smart television.

The user may enter text 210 onto the canvas interface 205. In this illustrative example, the text 210 includes what appears to be three proper names, Uhysnwx 215, Contoso 220, and Amazon 225. As the user is entering the text 210 spelling correction may be performed. In the illustrative example of FIG. 2A, conventional spelling correction is performed and the results are displayed in the canvas interface 205. In the illustrative example of FIG. 2B, enhanced spelling correction is performed and the results are displayed in the canvas interface 205. More details of these differences are provided below.

Referring to FIG. 1, “misspellings” are first identified in the text 210 using a lexicon-based spell checker 105.

During lexicon-based spelling correction, the spell checking is based on the known terms in the lexicon. When a named entity which is not well known is typed, the lexicon-based spell checker 105 flags the names as being misspelled because the names would not be in the lexicon (e.g., Contoso 220 and Uhysnwx 215). Since Amazon 225 is well known, the named entity “Amazon” is already in the lexicon of the lexicon-based spell checker 105. Therefore, when Amazon 225 is typed into the canvas interface 205, it is not flagged as being misspelled.

Typically, at this point, visual indications are surfaced for each misspelling. As shown in the illustrative example of FIG. 2A, Contoso 220 and Uhysnwx 215 are flagged as being misspelled and visual indications are surfaced for each misspelling. In particular, visual indication 250 is surfaced for Uhysnwx 215 and visual indication 255 is surfaced for Contoso 220.

As previously described, lexicon-based spelling correction approaches have high flagging recall, which as illustrated in FIG. 2A, results in flagging of words, such as named entities, that are not actually misspellings. Advantageously, the described enhanced spelling correction facilitates the use of an error confidence signal to reduce the number of false error flags on named entities and decision logic to reduce the likelihood that a true error flag is unflagged.

Returning for FIG. 1, each misspelling identified through the lexicon-based spelling correction is communicated to a language model-based spell checker 110. The language model-based spell checker 110 provides an error confidence level for each misspelling. The error confidence level can be a signal that indicates a confidence that the identified spelling error is an actual error. In the illustrative example of FIG. 1, Uhysnwx 215 is indicated as having a medium/high error confidence level and Contoso 220 is indicated as having a low error confidence level.

It should be understood that any suitable form of a confidence signal may be provided, depending on the particular language model-based spell checker, including but not limited to, a number between 0 and 1, a string with a particular meaning (e.g., low, medium, or high), or some other indicia of confidence.

In the illustrative example, in cases where the error confidence level indicates a medium/high confidence that the identified spelling error is an actual error, the error flag is maintained, and a visual indication of the spelling error is surfaced. As shown in the illustrative example of FIG. 2B, since the error confidence level of Uhysnwx 215 is medium/high, a visual indication 250 is surfaced for Uhysnwx 215. In some cases, spelling suggestions 115 can be provided for the misspelling.

However, as previously described, language model-based spelling correction can encounter low flagging recall as it can be skewed by commonly mistyped words. Therefore, before indicating that an error flag for a misspelling having a low error confidence level is a false error flag (e.g., the identified spelling error is not an actual error) and suppressing the error flag, decision logic is applied to the misspelling. The decision logic can be applied to determine whether to maintain or suppress the error flag. The decision logic can include a linguistic rule set to help ensure that linguistic rules are adhered to as well as eliminating common mistakes that language models may have.

Continuing with FIG. 1, since Contoso 220 is indicated as having a low error confidence level, decision logic 120 is applied to determine whether to maintain or suppress the error flag.

The decision logic 120 includes a rule set in which one or more rules may be applied to a misspelling to determine if the error flag assigned to the misspelling should be suppressed. The rule set may be a linguistic rule set to ensure that linguistic guidelines are adhered to.

The one or more rules of a particular rule set can include, but are not limited to, that the misspelling starts with an uppercase character (e.g., indicating possible named entity); the misspelling does not have more than two repeating characters; the misspelling does not have a trailing uppercase character; and the misspelling does not contain non-word characters. Non-word characters can include, for example, numbers and punctuation.

If each of the one or more rules in the rule set of the decision logic 120 is adhered to, then the error flag can be suppressed. In the illustrative example of FIG. 1, Contoso 220 adheres to each of the one or more rules in the rule set of the decision logic 120 and the error flag is suppressed.

A more detailed discussion of the decision logic will be provided later.

As can be seen in the illustrative example of FIG. 2B, since the error flag of Contoso 220 is suppressed, a visual indication of the spelling error is not shown.

An example of the enhanced spelling correction where the error flag would be maintained for a misspelling with a low confidence level from the language model-based spell checker 110 would be if Contoso 220 had a capital “T.” The language model-based spell checker 110 may still determine that “ConToso” has a low error confidence level if users frequently type the name. However, in this case, “ConToso” would not adhere to the rules in the example rule set of the decision logic because it has a trailing uppercase character. Therefore, the error flag would be maintained.

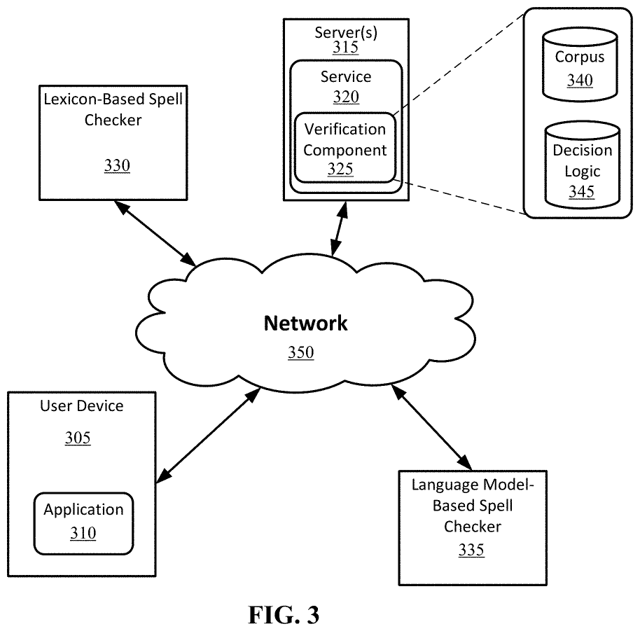

FIG. 3 illustrates an example operating environment for enhanced spelling correction. Referring to FIG. 3, the example operating environment may include a user device 305 running application 310, an enhanced spelling correction server 315 implementing an enhanced spelling correction service 320 having a verification component 325, a lexicon-based spell checker 330, and a language model-based spell checker 335.

User device 305 may be a general-purpose device that has the ability to run one or more applications, such as application 310. The user device 305 may be, but is not limited to, a personal computer, a laptop computer, a desktop computer, a tablet computer, a reader, a mobile device, a personal digital assistant, a smart phone, a gaming device or console, a wearable computer, a wearable computer with an optical head-mounted display, smart watch, or a smart television.

Application 310 may be any suitable application, such as a productivity application. The application 310 may be an application with an enhanced spelling correction feature or may be a web browser or front-end application that accesses the application with the enhanced spelling feature over the Internet or other network.

The lexicon-based spell checker 330 and the language model-based spell checker 335 can be provided by services separate from the enhanced spelling correction service 320. In some cases, the lexicon-based spell checker 330 and the language model-based spell checker 335 can be provided by the entity managing the enhanced spelling correction service 320. In some cases, the lexicon-based spell checker 330 can be a lexicon-based orthographic spell checker. The language model-based spell checker 335 can be any suitable language model-based spell checker, such as provided by MICROSOFT BING.

The verification component 325 of the enhanced spelling correction service 320 can include a corpus 340 and decision logic 345. The corpus 340 can be a lexicon comprising information related to, for example, areas of dialectal variation, archaic language (e.g., archaisms), colloquial language (e.g., colloquialisms), common misspellings, and offensive language.

Dialectal variation refers to the changes in a language due to influences, such as social and geographic influences. Dialectal variations include English as used in the United States (en-US) and English used in Ireland (en-IE). For example, “color” is the spelling used in the United States and “colour” is the spelling used in Ireland.

Archaic language refers to words no longer in everyday use or words that have lost a particular meaning in current usage. An example of archaic language is the second-person singular pronoun “thou.”

Colloquial language refers to informal words, phrases, or even slang. Examples of colloquial language include the spelling of “going to” as “gonna” or the spelling of “want to” as “wanna.”

Common misspellings include words that are frequently misspelled. Examples of common misspellings include the spelling of “separate” as “seperate” or the spelling of “calendar” as “calender.”

It should be understood that the corpus may be updated, and information may be added or removed. Additionally, one or more additional corpora may be added to the verification component 325 or communicated with by the enhanced spelling correction service 320. The corpus may be any suitable corpus.

The decision logic 345 includes a rule set in which one or more rules may be applied to a misspelling to determine if the error flag assigned to the misspelling should be suppressed. The rule set may be a linguistic rule set to ensure that linguistic guidelines are adhered to.

The one or more rules can include, for example, that an error confidence signal indicates a low confidence that the misspelling is an actual spelling error. In this case, the error confidence signal received from the language model-based spell checker 335 is analyzed to determine if the signal indicates a low confidence that the misspelling is an actual spelling error.

The one or more rules can further include, for example, that the misspelling starts with an uppercase character; the misspelling does not have more than two repeating characters; the misspelling does not have a trailing uppercase character; and the misspelling does not contain non-word characters. Non-word characters can include, for example, numbers and punctuation.

For the rule that the misspelling starts with an uppercase character, the misspelling is analyzed to determine whether the first character of the misspelling is an uppercase letter.

For the rule that the misspelling does not have more than two repeating characters, the misspelling is analyzed to determine whether the misspelling has more than two repeating characters.

For the rule that the misspelling does not contain non-word characters, the misspelling is analyzed to determine whether the misspelling contains a non-word character, such as a number or punctuation.

Another example of the one or more rules is that the misspelling must not a rejected form. For this rule, the misspelling is checked against words in the corpus 340 to determine whether the misspelling is contained within the corpus 340.

Another example of the one or more rules is that the suffix of the misspelling is consistent with nouns. For this rule, the misspelling is analyzed to determine whether the suffix of the misspelling contains a gerund or past participle or has a form consistent with a superlative or a comparative.

Yet another example of the one or more rules is that spelling suggestions provided for the misspelling include a satisfactory spelling suggestion. For this rule, the spelling suggestions provided for the misspelling are analyzed to determine if the spelling suggestions comprise one or more satisfactory spelling suggestions. Examples of a satisfactory spelling suggestion include, but are not limited to, a spelling suggestion that contains a space, a spelling suggestion that is a substring of the misspelling; a spelling suggestion that has the misspelling as a substring; and a spelling suggestion that contains non-word characters (e.g., numbers or punctuation).

As an illustrative example, if the text of a misspelling includes “Twowords,” then a satisfactory spelling suggestion that contains a space would include “Two words.” As another illustrative example, if the text of a misspelling includes “Townf,” then a satisfactory spelling suggestion that is a substring of the misspelling would include “Town.” As yet another illustrative example, if the text of a misspelling includes “hasnt,” then a satisfactory spelling suggestion that contains non-word characters would include “hasn't.”

It should be understood that the rule set may include more or fewer rules. The one or more rules may be any suitable rule and may be applied in any order as long as the order achieves a desired outcome. For example, the order of the rules can function as a set of filters, where a subsequent rule only makes sense to indicate an error if the preceding rule is met (e.g., capitalized first letter to indicate named entity should precede a rule checking that the term is a noun because not all misspellings will be nouns, but named entities will be). It should be understood that the enhanced spelling correction service 320 may include one or more additional verification components. The verification component 325 can be adaptable to any language and is not tied to one specific language scenario.

It should be understood that all or part of the enhanced spelling correction service 320 may be resident on the user device, distributed across multiple machines, or even resident on a cloud service. The singular “enhanced spelling correction service” may, in fact, be composed of multiple sub-services in communication with one another. The physical location of the enhanced spelling correction service or its constituent sub-services will vary by implementation.

Various types of physical or virtual computing systems may be used to implement the enhanced spelling correction service 320, such as server computers, desktop computers, laptop computers, tablet computers, smart phones, or any other suitable computing appliance. When implemented using a server computer, any of a variety of servers may be used including, but not limited to, application servers, database servers, mail servers, rack servers, blade servers, tower servers, or any other type server, variation of server, or combination thereof.

Components (computing systems, storage resources, and the like) in the operating environment may operate on or in communication with each other over a network 350. The network 350 can be, but is not limited to, a cellular network (e.g., wireless phone), a point-to-point dial up connection, a satellite network, the Internet, a local area network (LAN), a wide area network (WAN), a WiFi network, an ad hoc network or a combination thereof. Such networks are widely used to connect various types of network elements, such as hubs, bridges, routers, switches, servers, and gateways. The network 350 may include one or more connected networks (e.g., a multi-network environment) including public networks, such as the Internet, and/or private networks such as a secure enterprise private network. Access to the network 350 may be provided via one or more wired or wireless access networks as understood by those skilled in the art.

Communication to and from the components, such as from the enhanced spelling correction feature and the enhanced spelling correction service, may be carried out, in some cases, via application programming interfaces (APIs). An API is an interface implemented by a program code component or hardware component (hereinafter “API-implementing component”) that allows a different program code component or hardware component (hereinafter “API-calling component”) to access and use one or more functions, methods, procedures, data structures, classes, and/or other services provided by the API-implementing component. An API can define one or more parameters that are passed between the API-calling component and the API-implementing component. The API is generally a set of programming instructions and standards for enabling two or more applications to communicate with each other and is commonly implemented over the Internet as a set of Hypertext Transfer Protocol (HTTP) request messages and a specified format or structure for response messages according to a REST (Representational state transfer) or SOAP (Simple Object Access Protocol) architecture.

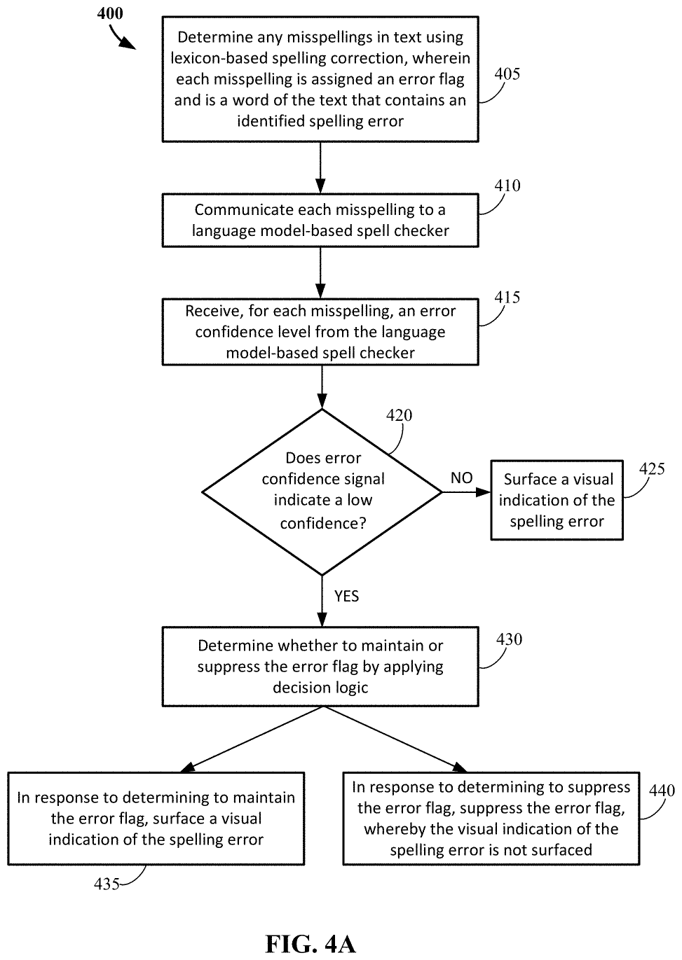

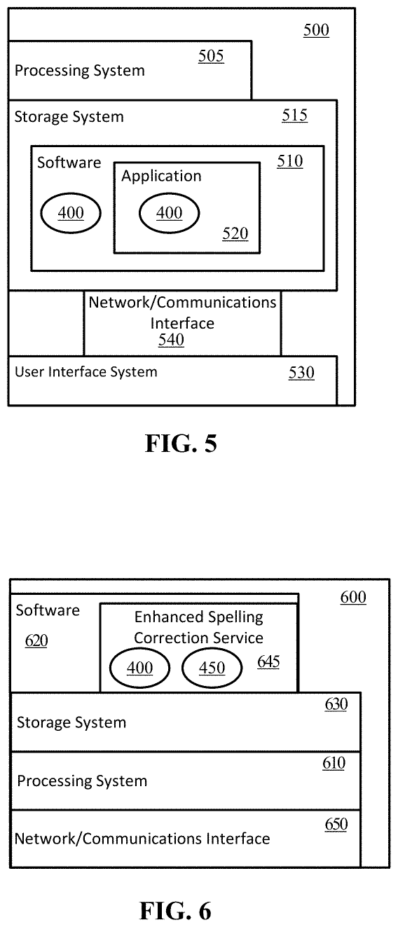

FIG. 4A illustrates an example process flow diagram for enhanced spelling correction according to certain embodiments of the invention. Referring to both FIG. 3 and FIG. 4A, the enhanced spelling correction service 320 performing process 400, can be implemented by the enhanced spelling correction server 315, which can be embodied as described with respect to computing system 600 as shown in FIG. 6 and even, in whole or in part, by user device 305 (and in some cases integrated with application 310), which can be embodied as described with respect to computing system 500 as shown in FIG. 5.

The enhanced spelling correction service 320 can determine (405) any misspellings in text using lexicon-based spelling correction at the lexicon-based spell checker 330. A misspelling is a word of the text that contains an identified spelling error, and each misspelling is assigned an error flag. A word refers to the characters between spaces. In some cases, the text can be tokenized and the enhanced spelling correction can be performed on each token.

In some cases, spelling suggestions can also be determined by the lexicon-based spell checker 330. The spelling suggestions can be the standard spelling suggestions provided by a lexicon-based spell checker.

Typically, at this point, a visual indication of the spelling error would be surfaced for the text. However, with the enhanced spelling correction described in process 400, each misspelling is further analyzed through the use of the language model-based spell checker 335 and the verification component 325.

The enhanced spelling correction service 320 can communicate (410) each misspelling to the language model-based spell checker 335. The enhanced spelling correction service 320 can receive (415) an error confidence signal from the language model-based spell checker 335. The error confidence signal can be received for each of the misspellings.

The error confidence signal received for each misspelling can indicate a confidence that the identified spelling error is an actual spelling error. In some cases, the error confidence signal may be a string with a particular meaning, such as low, medium, or high. In some cases, the error confidence signal may be a value, such as a number from zero to one. For example, a misspelling may have a low confidence if the value is below a certain threshold value. In some cases, the error confidence signal may be received as a string and transformed into an integer value.

The enhanced spelling correction service 320 can check (420) if the error confidence signal for each misspelling indicates a low confidence that the identified spelling error is an actual spelling error.

For each misspelling having an error confidence signal that does not indicate a low confidence that the identified spelling error is an actual spelling error, the enhanced spelling correction service 320, when incorporated in a productivity application, can surface (425) a visual indication of the spelling error. In cases where the error confidence signal does not indicate a low confidence that the identified spelling error is an actual spelling error, both the lexicon-based spell checker 330 and the language model-based spell checker 335 agree that the word associated with the misspelling has a spelling error. Thus, the error flag is maintained and the visual indication is surfaced.

The visual indication can be any suitable visual indication, such as an underline or a highlight. In some cases, spelling suggestions may also be provided for the misspelling. The spelling suggestions may be provided for the misspelling from the lexicon-based spell checker 330 or the language model-based spell checker 335.

For each misspelling having an error confidence signal indicating a low confidence that the identified spelling error is an actual spelling error, the enhanced spelling correction service 320 can determine (430) whether to maintain or suppress the error flag by applying decision logic 345.

In cases where the error confidence signal indicates a low confidence that the identified spelling error is an actual spelling error, the lexicon-based spell checker 330 and the language model-based spell checker 335 are not in agreement that the word associated with the misspelling has a spelling error. The decision logic 345 is applied in order to maintain an adherence to linguistic guidelines. Therefore, if a misspelling has an error confidence signal indicating a low confidence that the identified spelling error is an actual spelling error and adheres to a rule set of the decision logic, then the error flag for that misspelling can be suppressed.

As previously described, the decision logic 345 includes a rule set in which one or more rules may be applied to a misspelling to determine if the error flag assigned to the misspelling should be suppressed. The one or more rules may be linguistic rules.

In some cases, the use of an error confidence signal can reduce the number of false error flag on named entities and decision logic can be used to reduce the likelihood that a true error flag is unflagged. For example, the decision logic can focus on what a proper name looks like without developing something like a named entity recognizer and while also minimizing common error types that language models don't capture.

In an example rule set for decision logic used to reduce the likelihood that a true error flag is unflagged on named entities, the one or more rules can include, for example, that the misspelling starts with an uppercase character; the misspelling does not have more than two repeating characters; the misspelling does not have a trailing uppercase character; and the misspelling does not contain non-word characters. Non-word characters can include, for example, numbers and punctuation.

For the rule that the misspelling starts with an uppercase character, the misspelling is analyzed to determine whether the first character of the misspelling is an uppercase letter. If the first character of the misspelling is an uppercase character, then the misspelling proceeds to the next rule.

For the rule that the misspelling does not have more than two repeating characters, the misspelling is analyzed to determine whether the misspelling has more than two repeating characters. If the misspelling has more than two repeating characters, then the error flag is maintained. If the rule is adhered to, the misspelling can proceed to the next rule.

For the rule that the misspelling does not contain non-word characters, the misspelling is analyzed to determine whether the misspelling contains a non-word character, such as a number or punctuation. If the misspelling contains a non-word character, then the error flag is maintained. If the rule is adhered to, the misspelling can proceed to the next rule.

In some cases, the one or more rules can further include a rule that the misspelling must not a rejected form. For this rule, the misspelling is checked against words in the corpus 340 to determine whether the misspelling is contained within the corpus 340. If the misspelling is contained in the corpus 340, then the error flag is maintained. If the rule is adhered to, the misspelling can proceed to the next rule.

As an illustrative example, the misspelling may be a late 19th century word that might have been in common use in that time period. Typically, the word could be unflagged because it may be a word that can be looked up in a current dictionary. However, in this illustrative example, it would be a rejected form because it's not within common use and would be contained in the corpus 340. Thus, the error flag would still be upheld.

In some cases, the one or more rules can further include a rule that the suffix of the misspelling is consistent with nouns. For this rule, the misspelling is analyzed to determine whether the suffix of the misspelling contains a gerund or past participle or has a form consistent with a superlative or a comparative. If the suffix of the misspelling contains a gerund or past participle or has a form consistent with a superlative or a comparative, then the error flag is maintained. If the rule is adhered to, the misspelling can proceed to the next rule.

In some cases, the one or more rules can further include a rule that spelling suggestions provided for the misspelling include a satisfactory spelling suggestion. For this rule, the spelling suggestions provided for the misspelling are analyzed to determine if the spelling suggestions comprise one or more satisfactory spelling suggestions. Examples of a satisfactory spelling suggestion include, but are not limited to, a spelling suggestion that contains a space, a spelling suggestion that is a substring of the misspelling; a spelling suggestion that has the misspelling as a substring; and a spelling suggestion that contains non-word characters (e.g., numbers or punctuation). If the spelling suggestions provided for the misspelling comprise one or more satisfactory spelling suggestions, then the error flag is maintained.

If each of the rules in the rule set is adhered to, the enhanced spelling correction service 320 can determine to suppress the error flag.

Optimizations may be performed to minimize any latency issues. As an example, the order that the rules are applied can be changed or the rule set can be fine-tuned. For example, rules containing less complicated calculations can be applied first, then the rules containing more complicated calculations can be applied after. In another example, regular expressions can be used. In this case, the regular expressions can be previously loaded in memory instead of generated on the fly.

In response to determining to maintain the error flag, the enhanced spelling correction service 320 when incorporated in a productivity application can surface (435) a visual indication of the spelling error. In some cases, spelling suggestions may also be surfaced for the misspelling.

In response to determining to suppress the error flag, the enhanced spelling correction service 320 can suppress (440) the error flag, whereby the visual indication of the spelling error is not surfaced.

FIG. 4B illustrates an example process flow diagram for enhanced spelling correction according to certain embodiments of the invention. Referring to both FIG. 3 and FIG. 4B, the enhanced spelling correction service 320 performing process 450, can be implemented by the enhanced spelling correction server 315, which can be embodied as described with respect to computing system 600 as shown in FIG. 6 and even, in whole or in part, by user device 305, which can be embodied as described with respect to computing system 500 as shown in FIG. 5. In this example, the lexicon-based spell checker 330 is separate from the enhanced spelling correction service 320 and the application 310 is separate from the enhanced spelling correction service 320.

The enhanced spelling correction service 320 can communicate (455) text to a lexicon-based spell checker 330. The lexicon-based spell checker 330 can perform lexicon-based spelling correction on the text. The text may be any text included in a productivity application. For example, the text may be included in a document, presentation, spreadsheet, database, chart and graph, or the like.

The enhanced spelling correction service 320 can receive (460) any misspellings in the text from the lexicon-based spell checker 330. A misspelling is a word of the text that contains an identified spelling error, and each misspelling is assigned an error flag.

In some cases, spelling suggestions can also be determined by the lexicon-based spell checker 330 and received with the misspellings. The spelling suggestions can be the standard spelling suggestions provided by a lexicon-based spell checker.

Typically, at this point, a visual indication of the spelling error would be surfaced in the display (at user device 305). However, with the enhanced spelling correction described in process 450, each misspelling is further analyzed through the use of the language model-based spell checker 335 and the verification component 325.

The enhanced spelling correction service 320 can communicate (465) each misspelling to the language model-based spell checker 335. The enhanced spelling correction service 320 can receive (470) an error confidence signal from the language model-based spell checker 335. The error confidence signal can be received for each of the misspellings.

The error confidence signal received for each misspelling can indicate a confidence that the identified spelling error is an actual spelling error. In some cases, the error confidence signal may be a string with a particular meaning, such as low, medium, or high. In some cases, the error confidence signal may be a value, such as a number from zero to one. For example, a misspelling may have a low confidence if the value is below a certain threshold value.

The enhanced spelling correction service 320 can check (475) if the error confidence signal for each misspelling indicates a low confidence that the identified spelling error is an actual spelling error.

For each misspelling having an error confidence signal that does not indicate a low confidence that the identified spelling error is an actual spelling error, the enhanced spelling correction service 320 can provide (480) the error flag. The error flag can be provided to the application which the text is included. The error flag indicates that a visual indication of the spelling error is to be surfaced. The application (e.g., application 310) can then surface (482) the visual indication of the spelling error. In cases where the error confidence signal does not indicate a low confidence that the identified spelling error is an actual spelling error, both the lexicon-based spell checker 330 and the language model-based spell checker 335 agree that the word associated with the misspelling has a spelling error. Thus, the error flag is maintained and the visual indication is surfaced.

The visual indication can be any suitable visual indication, such as an underline or a highlight. In some cases, the visual indication is an editor pane of the application 310. In some cases, spelling suggestions may also be provided for the misspelling. The spelling suggestions may be provided for the misspelling from the lexicon-based spell checker 330 or the language model-based spell checker 335.

For each misspelling having an error confidence signal indicating a low confidence that the identified spelling error is an actual spelling error, the enhanced spelling correction service 320 can determine (485) whether to maintain or suppress the error flag by applying decision logic 345.

In cases where the error confidence signal indicates a low confidence that the identified spelling error is an actual spelling error, the lexicon-based spell checker 330 and the language model-based spell checker 335 are not in agreement that the word associated with the misspelling has a spelling error. The decision logic 345 is applied in order to maintain an adherence to linguistic guidelines. Therefore, if a misspelling has an error confidence signal indicating a low confidence that the identified spelling error is an actual spelling error and adheres to a rule set of the decision logic, then the error flag for that misspelling can be suppressed.

As previously described, the decision logic 345 includes a rule set in which one or more rules may be applied to a misspelling to determine if the error flag assigned to the misspelling should be suppressed. The one or more rules may be linguistic rules.

If each of the rules in the rule set is adhered to, the enhanced spelling correction service 320 can determine to suppress the error flag.

In response to determining to maintain the error flag, the enhanced spelling correction service 320 can provide (490) the error flag. The error flag can be provided to the application which the text is included. The error flag indicates that a visual indication of the spelling error is to be surfaced. The application can then surface (492) the visual indication of the spelling error. In some cases, spelling suggestions may also be surfaced for the misspelling.

In response to determining to suppress the error flag, the enhanced spelling correction service 320 can suppress (495) the error flag, whereby the error flag is not provided, such that no visual indication of the spelling error is surfaced.

FIG. 5 illustrates components of a computing device that may be used in certain embodiments described herein; and FIG. 6 illustrates components of a computing system that may be used to implement certain methods and services described herein.

Referring to FIG. 5, system 500 may represent a computing device such as, but not limited to, a personal computer, a reader, a mobile device, a personal digital assistant, a wearable computer, a smart phone, a tablet, a laptop computer (notebook or netbook), a gaming device or console, an entertainment device, a hybrid computer, a desktop computer, or a smart television. Accordingly, more or fewer elements described with respect to system 500 may be incorporated to implement a particular computing device.

System 500 includes a processing system 505 of one or more processors to transform or manipulate data according to the instructions of software 510 stored on a storage system 515. Examples of processors of the processing system 505 include general purpose central processing units, application specific processors, and logic devices, as well as any other type of processing device, combinations, or variations thereof. The processing system 505 may be, or is included in, a system-on-chip (SoC) along with one or more other components such as network connectivity components, sensors, video display components.

The software 510 can include an operating system (OS) and application programs such as application 520 that calls (and in some cases incorporates) the enhanced spelling correction service as described herein or software performing process 400 as described with respect to FIG. 4A. In some cases, application 520 can perform process 400 as described with respect to FIG. 4A. Device operating systems generally control and coordinate the functions of the various components in the computing device, providing an easier way for applications to connect with lower level interfaces like the networking interface.

Storage system 515 may comprise any computer readable storage media readable by the processing system 505 and capable of storing software 510 including the application 520.

Storage system 515 may include volatile and nonvolatile memories, removable and non-removable media implemented in any method or technology for storage of information, such as computer readable instructions, data structures, program modules, or other data. Examples of storage media of storage system 515 include random access memory, read only memory, magnetic disks, optical disks, CDs, DVDs, flash memory, magnetic cassettes, magnetic tape, magnetic disk storage or other magnetic storage devices, or any other suitable storage media. In no case is the storage medium a transitory propagated signal.

Storage system 515 may be implemented as a single storage device but may also be implemented across multiple storage devices or sub-systems co-located or distributed relative to each other. Storage system 515 may include additional elements, such as a controller, capable of communicating with processing system 505.

Software 510 may be implemented in program instructions and among other functions may, when executed by system 500 in general or processing system 505 in particular, direct system 500 or the one or more processors of processing system 505 to operate as described herein.

The system can further include user interface system 530, which may include input/output (I/O) devices and components that enable communication between a user and the system 500. User interface system 530 can include input devices such as a mouse, track pad, keyboard, a touch device for receiving a touch gesture from a user, a motion input device for detecting non-touch gestures and other motions by a user, a microphone for detecting speech, and other types of input devices and their associated processing elements capable of receiving user input.

The user interface system 530 may also include output devices such as display screen(s), speakers, haptic devices for tactile feedback, and other types of output devices. In certain cases, the input and output devices may be combined in a single device, such as a touchscreen, or touch-sensitive, display which both depicts images and receives touch gesture input from the user.

Visual output may be depicted on the display (not shown) in myriad ways, presenting graphical user interface elements, text, images, video, notifications, virtual buttons, virtual keyboards, or any other type of information capable of being depicted in visual form.

The user interface system 530 may also include user interface software and associated software (e.g., for graphics chips and input devices) executed by the OS in support of the various user input and output devices. The associated software assists the OS in communicating user interface hardware events to application programs using defined mechanisms. The user interface system 530 including user interface software may support a graphical user interface, a natural user interface, or any other type of user interface. For example, the canvas interfaces for the application 520 described herein may be presented through user interface system 530.

Network interface 540 may include communications connections and devices that allow for communication with other computing systems over one or more communication networks (not shown). Examples of connections and devices that together allow for inter-system communication may include network interface cards, antennas, power amplifiers, RF circuitry, transceivers, and other communication circuitry. The connections and devices may communicate over communication media (such as metal, glass, air, or any other suitable communication media) to exchange communications with other computing systems or networks of systems. Transmissions to and from the communications interface are controlled by the OS, which informs applications of communications events when necessary.

Certain aspects described herein, such as those carried out by the enhanced spelling correction service described herein may be performed on a system such as shown in FIG. 6. Referring to FIG. 6, system 600 may be implemented within a single computing device or distributed across multiple computing devices or sub-systems that cooperate in executing program instructions. The system 600 can include one or more blade server devices, standalone server devices, personal computers, routers, hubs, switches, bridges, firewall devices, intrusion detection devices, mainframe computers, network-attached storage devices, and other types of computing devices. The system hardware can be configured according to any suitable computer architectures such as a Symmetric Multi-Processing (SMP) architecture or a Non-Uniform Memory Access (NUMA) architecture.

The system 600 can include a processing system 610, which may include one or more processors and/or other circuitry that retrieves and executes software 620 from storage system 630. Processing system 610 may be implemented within a single processing device but may also be distributed across multiple processing devices or sub-systems that cooperate in executing program instructions.

Storage system(s) 630 can include any computer readable storage media readable by processing system 610 and capable of storing software 620. Storage system 630 may be implemented as a single storage device but may also be implemented across multiple storage devices or sub-systems co-located or distributed relative to each other. Storage system 630 may include additional elements, such as a controller, capable of communicating with processing system 610.

Software 620, including enhanced spelling correction service 645, may be implemented in program instructions and among other functions may, when executed by system 600 in general or processing system 610 in particular, direct the system 600 or processing system 610 to operate as described herein for the enhanced spelling correction service (and its various components and functionality). The enhanced spelling correction service 645 can perform processes 400 and/or 450 as described with respect to FIG. 4A and FIG. 4B, respectively.

System 600 may represent any computing system on which software 620 may be staged and from where software 620 may be distributed, transported, downloaded, or otherwise provided to yet another computing system for deployment and execution, or yet additional distribution.

In embodiments where the system 600 includes multiple computing devices, the server can include one or more communications networks that facilitate communication among the computing devices. For example, the one or more communications networks can include a local or wide area network that facilitates communication among the computing devices. One or more direct communication links can be included between the computing devices. In addition, in some cases, the computing devices can be installed at geographically distributed locations. In other cases, the multiple computing devices can be installed at a single geographic location, such as a server farm or an office.

A network/communication interface 650 may be included, providing communication connections and devices that allow for communication between system 600 and other computing systems (not shown) over a communication network or collection of networks (not shown) or the air.

Certain techniques set forth herein with respect to the application and/or enhanced spelling correction service may be described in the general context of computer-executable instructions, such as program modules, executed by one or more computing devices. Generally, program modules include routines, programs, objects, components, and data structures that perform particular tasks or implement particular abstract data types.

Alternatively, or in addition, the functionality, methods and processes described herein can be implemented, at least in part, by one or more hardware modules (or logic components). For example, the hardware modules can include, but are not limited to, application-specific integrated circuit (ASIC) chips, field programmable gate arrays (FPGAs), system-on-a-chip (SoC) systems, complex programmable logic devices (CPLDs) and other programmable logic devices now known or later developed. When the hardware modules are activated, the hardware modules perform the functionality, methods and processes included within the hardware modules.

Embodiments may be implemented as a computer process, a computing system, or as an article of manufacture, such as a computer program product or computer-readable medium. Certain methods and processes described herein can be embodied as software, code and/or data, which may be stored on one or more storage media. Certain embodiments of the invention contemplate the use of a machine in the form of a computer system within which a set of instructions, when executed, can cause the system to perform any one or more of the methodologies discussed above. Certain computer program products may be one or more computer-readable storage media readable by a computer system (and executable by a processing system) and encoding a computer program of instructions for executing a computer process. It should be understood that as used herein, in no case do the terms “storage media”, “computer-readable storage media” or “computer-readable storage medium” consist of transitory propagating signals.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

1. A method comprising:
determining any misspellings in text using lexicon-based spelling correction, wherein a misspelling is a word of the text that contains an identified spelling error and each misspelling is assigned an error flag;
communicating, over a network, each misspelling to a server hosting a language model-based spell checker;
receiving over the network, for each misspelling, an error confidence signal from the language model-based spell checker; and
for each misspelling having an error confidence signal indicating a low confidence that the identified spelling error is an actual spelling error:
determining whether to maintain or suppress the error flag by applying decision logic;
in response to determining to maintain the error flag, surfacing a visual indication of a spelling error; and
in response to determining to suppress the error flag, suppressing the error flag whereby the visual indication of the spelling error is not surfaced.

2. The method of claim 1, wherein applying the decision logic comprises:
determining whether the misspelling is contained within a corpus comprising archaisms, colloquialisms, common misspellings, or a combination thereof; and
responsive to the misspelling being contained within the corpus, determining to maintain the error flag.

3. The method of claim 1, wherein applying the decision logic comprises:
determining whether spelling suggestions provided for the misspelling comprise one or more satisfactory spelling suggestions; and
responsive to the spelling suggestions comprising the one or more satisfactory spelling suggestions, determining to maintain the error flag.

4. The method of claim 3, wherein a satisfactory spelling suggestion comprises a spelling suggestion containing a space, a spelling suggestion that is a substring of the misspelling, a spelling suggestion that has the misspelling as a substring, a spelling suggestion containing non-word characters, or a combination thereof.

5. The method of claim 1, wherein applying the decision logic comprises:
determining whether the misspelling has more than two repeating characters; and
responsive to the misspelling having the more than two repeating characters, determining to maintain the error flag.

6. The method of claim 1, wherein applying the decision logic comprises:
determining whether the misspelling has a trailing uppercase character; and
responsive to the misspelling having the trailing uppercase character, determining to maintain the error flag.

7. The method of claim 1, wherein applying the decision logic comprises:
determining whether a suffix of the misspelling comprises a gerund, a past participle, a form consistent with a superlative, or a form consistent with a comparative; and
responsive to the suffix of the misspelling comprising the gerund, the past participle, the form consistent with the superlative, or the form consistent with the comparative, determining to maintain the error flag.

8. The method of claim 1, wherein applying the decision logic comprises:
determining whether the misspelling contains a non-word character; and
responsive to the misspelling containing the non-word character, determining to maintain the error flag.

9. The method of claim 1, wherein the error confidence signal is a value, wherein the value of the error confidence signal indicating a low confidence that the identified spelling error is an actual spelling error is below a threshold value.

10. The method of claim 1, wherein the error confidence signal is a string, wherein the string for the error confidence signal indicating a low confidence that the identified spelling error is an actual spelling error is low.

11. The method of claim 1, further comprising, for each misspelling having an error confidence signal indicating a medium or high confidence that the identified spelling error is an actual spelling error, surfacing a visual indication of the spelling error.

12. A computer readable storage medium having instructions stored thereon that, when executed by a processing system, perform a method comprising:
communicating, over a network, text to a server hosting a lexicon-based spell checker;
receiving any misspellings in the text, wherein a misspelling is a word of the text that contains an identified spelling error and each misspelling is assigned an error flag;
communicating, over the network, each misspelling to a server hosting a language model-based spell checker;
receiving over the network, for each misspelling, an error confidence signal from the language model-based spell checker; and
for each misspelling having an error confidence signal indicating a low confidence that the identified spelling error is an actual spelling error:
determining whether to maintain or suppress the error flag by applying decision logic;
in response to determining to maintain the error flag, providing the error flag indicating a visual indication of a spelling error is to be surfaced; and
in response to determining to suppress the error flag, suppressing the error flag whereby the error flag is not provided, and the visual indication of the spelling error is not surfaced.

13. The medium of claim 12, wherein applying the decision logic comprises:
determining whether the misspelling is contained within a corpus comprising archaisms, colloquialisms, common misspellings, or a combination thereof; and
responsive to the misspelling being contained within the corpus, determining to maintain the error flag.

14. The medium of claim 12, wherein applying the decision logic comprises:
determining whether spelling suggestions provided for the misspelling comprise one or more satisfactory spelling suggestions, wherein a satisfactory spelling suggestion comprises a spelling suggestion containing a space, a spelling suggestion that is a substring of the misspelling, a spelling suggestion that has the misspelling as a substring, a spelling suggestion containing non-word characters, or a combination thereof; and
responsive to the spelling suggestions comprising the one or more satisfactory spelling suggestions, determining to maintain the error flag.

15. The medium of claim 12, wherein applying the decision logic comprises:
determining whether the misspelling has more than two repeating characters; and
responsive to the misspelling having the more than two repeating characters, determining to maintain the error flag.

16. A system comprising:
a processing system;
a storage system; and
instructions stored on the storage system that, when executed by the processing system, direct the processing system to:
determine any misspellings in text using lexicon-based spelling correction, wherein a misspelling is a word of the text that contains an identified spelling error and each misspelling is assigned an error flag;
communicate, over a network, each misspelling to a server hosting a language model-based spell checker;
receive over the network, for each misspelling, an error confidence signal from the language model-based spell checker; and
for each misspelling having an error confidence signal indicating a low confidence that the identified spelling error is an actual spelling error:
determine whether to maintain or suppress the error flag by applying decision logic;
in response to determining to maintain the error flag, surface a visual indication of a spelling error; and
in response to determining to suppress the error flag, suppress the error flag whereby the visual indication of the spelling error is not surfaced.

17. The system of claim 16, wherein the instructions to apply the decision logic direct the processing system to:
determine whether the misspelling has a trailing uppercase character; and
responsive to the misspelling having the trailing uppercase character, determine to maintain the error flag.

18. The system of claim 16, wherein the instructions to apply the decision logic direct the processing system to:
determine whether a suffix of the misspelling comprises a gerund, a past participle, a form consistent with a superlative, or a form consistent with a comparative; and
responsive to the suffix of the misspelling comprising the gerund, the past participle, the form consistent with the superlative, or the form consistent with the comparative, determine to maintain the error flag.

19. The system of claim 16, wherein the instructions to apply the decision logic direct the processing system to:
determine whether the misspelling contains a non-word character; and
responsive to the misspelling containing the non-word character, determine to maintain the error flag.

20. The system of claim 16, wherein the instructions to apply the decision logic direct the processing system to:
determine whether the misspelling is contained within a corpus comprising archaisms, colloquialisms, common misspellings, or a combination thereof; and
responsive to the misspelling being contained within the corpus, determine to maintain the error flag.
